(19) United States
(12) Patent Application Publication
(10) Pub. No.: US 2007/0086934 A1
(43) Pub. Date: Apr. 19, 2007

(54) Reformer system and method reforming

(75) Inventors: Jochem Huber, Muechen (DE); Juergen Ringler, Kissing (DE); Michael Preis, Koenigsbrunn (DE); Christian Liebl, Eching (DE); John Kirukin, Shelby Township, MI (US); Jean Botti, Troy, MI (US); Malcolm James Grieve, (US)

Correspondence Address: CROWELL & MORING LLP;INTELLECTUAL PROPERTY GROUP, P.O. BOX 14300, WASHINGTON, DC, 20044-4300, US

(73) Assignees: Bayerische Motoren Werke Aktiengesellschaft, Muenchen (DE); Delphi Technologies, Inc., Troy, MI (US)

(21) Appl. No.: 11/248,162

(22) Filed: Oct. 13, 2005

(51) Int. Cl. B01J 19/00; C01B 3/26; H01M 8/06

(52) U.S. Cl. 422/198; 423/652; 429/20; 429/17

(57) ABSTRACT

A reformer system has a reformer for converting a hydrocarbon-containing fuel to a hydrogen-gas-rich reformate gas, and an HC adsorber, which is connected to an output side of the reformer and adsorbs, as a function of temperature, hydrocarbons contained in the reformate gas, or for desorbing previously adsorbed hydrocarbons to the reformate gas. The reformer system transmits the reformate gas after passing through the HC adsorber to a consuming device. The chronological progression of the adsorption/desorption behavior of the HC adsorber during an operating phase of the reformer as a function of the reformate gas temperature occurring in the operating phase and/or a temperature gradient of the reformate gas occurring in the operating phase is coordinated with the chronological progression of the operating behavior of the consuming device such that a significant desorption of hydrocarbons from the HC adsorber takes place only when the consuming device is in an operating condition in which the desorbed hydrocarbons are processed by the consuming device such that the hydrocarbon fraction of the gases expelled from the consuming device and/or the function of the consuming device is/are not significantly influenced by the desorbed hydrocarbons.

### CROSS-REFERENCE TO RELATED APPLICATION

This application is related to co-pending U.S. patent application Ser. No. ______, entitled “Reformer System Having Electric Heating Devices”.

### BACKGROUND AND SUMMARY OF THE INVENTION

The invention relates to a reformer system having a reformer which is designed for converting a hydrocarbon-containing fuel to a hydrogen-gas-rich reformate gas, which can be obtained at an output of the reformer. The invention also relates to a vehicle having such a reformer system. Furthermore, the invention relates to a method of reforming a hydrocarbon-containing fuel with a conversion of the hydrocarbon-containing fuel to a hydrogen-rich reformate gas by using a reformation process.

Reformer systems are generally used in motor vehicle for generating a hydrogen-rich synthesis or reformate gas consisting of hydrogen (H₂), carbon monoxide (CO) and inert gas (N₂, CO₂, H₂O) from liquid or gaseous hydrocarbon-containing fuels. For this purpose, different reformation processes, among them, partial oxidation, steam reformation, CO₂ reformation, cracking, or combinations thereof (such as autothermal reformation) are known. For increasing the hydrogen yield, a so-called shift reaction may follow on the output side. The currently known usage and utilization possibilities of a reformate gas in a motor vehicle comprise the operation of a fuel cell, the feeding to an internal-combustion engine for minimizing cold-start/warm-up and engine out emissions of the same internal-combustion engine, as well as the aftertreatment of exhaust gases from the internal-combustion engine.

High temperatures are required for implementing the reformation processes in the reformer. When reforming gasoline or diesel, the temperatures may be between 800 and 1,500° C. For initiating the reformation reaction and a subsequent stable progression of the reaction, at least certain zones in the reformer have to be brought to a corresponding temperature. These areas are a mixture forming zone for forming an air/fuel mixture and, if required, partial areas of a catalyst for accelerating the reformation reaction.

As a rule, it is difficult to precisely control this starting process of a reformer, particularly when the reformation process has to start within a very short time period. High HC emissions may therefore occur, especially in the starting phase of the reformer. Thus, for example, a temperature outside an operating window of a catalyst used in the reformer can lead to a limitation of the desired reaction courses and/or an increased occurrence of undesirable secondary reactions. This has the tendency of causing higher pollutant emissions, among them, HC emissions. The increased HC emissions of the reformer, particularly in the starting phase, have a negative effect with respect to the further use of the reformate gas. When the reformate gas is used for operating a fuel cell, for example, the HC emissions may result in damage to the fuel cell. When the reformate gas is used for the start and/or for the further operation of an internal-combustion engine, high hydrocarbon fractions in the reformate gas may lead to an increase of the emissions of the internal-combustion engine.

In order to reduce the HC emissions, it is suggested in the state of the art to use vapors of easily boiling fuel constituents for starting the reformer. In the simplest case, these are either taken directly from the tank of a pertaining vehicle or are obtained by means of an HC adsorber connected on the output side of the tank. The use of fuel vapors taken from the fuel system by means of HC adsorbers is difficult because, for a fast and low-emission reformer start, on the one hand, defined air/fuel ratios have to be maintained and, on the other hand, the saturation condition of the adsorber with fuel vapor, and thus the quantity of fuel vapor which can be removed per time unit, as a rule, varies considerably or is unknown. As a result, the use of fuel vapors suggested in the state of the art leads to an unstable course of the reformation process.

An aspect of the invention is to provide a reformer system of the above-mentioned type, as well as a reforming method of the above-mentioned type, whereby a reformate gas may be produced in a stable reaction process. The reformate gas may be processed without any problem by a consuming device coupled on an output side.

According to the invention, a reformer system is provided having a reformer for converting a hydrocarbon-containing fuel to a hydrogen-gas-rich reformate gas, and an HC adsorber, which is connected to the output side of the reformer and is designed for adsorbing as a function of the temperature hydrocarbons contained in the reformate gas or for desorbing previously adsorbed hydrocarbons to the reformate gas. The reformer system is designed for transmitting the reformate gas, after passing through the HC adsorber to a consuming device. The chronological progression of the adsorption/desorption behavior of the HC adsorber during an operating phase of the reformer as a function of the reformate gas temperature occur in the operating phase, and/or a temperature gradient of the reformate gas occurring in the operating phase, is coordinated with the chronological progression of the operating behavior of the consuming device such that a significant desorption of hydrocarbons from the HC adsorber takes place. The significant desorption takes place only when the consuming device is in an operating condition in which the desorbed hydrocarbons are processed by the consuming device such that the hydrocarbon fraction of the gases expelled from the consuming device, and/or the function of the consuming device, is/are not significantly influenced by the desorbed hydrocarbons.

Furthermore, according to the invention, a method is provided for reforming a hydrocarbon-containing fuel with a conversion of the hydrocarbon-containing fuel to a hydrogen-rich reformate gas by the use of a reformation process, a temperature-dependent adsorbing of hydrocarbons contained in the reformate gas on an HC adsorber or desorbing of previously adsorbed hydrocarbons to the reformate gas, as well as a transmission of the reformate gas after passing through the HC adsorber to a consuming device. The chronological progression of the adsorption/desorption behavior of the HC-adsorber during an operating phase of the reformer as a function of the reformate gas temperature occurring in the operating phase, and/or a temperature gradient of the reformate gas occurring in the operating phase, is coordinated with the chronological progression of the operating behavior of the consuming device such that a significant desorption of hydrocarbons from the HC adsorber takes place. This occurs only when the consuming device is in an operating condition in which the desorbed hydrocarbons are processed by the consuming device such that the hydrocarbon fraction of the gases expelled from the consuming device, and/or the function of the consuming device, is/are not significantly influenced by the desorbed hydrocarbons.

As a result of the adsorption according to the invention of the hydrocarbons contained in the reformate gas by way of the HC adsorber, which adsorption follows the reformation process in the reformer, in the operation of the reformer during the operating phase, particularly during its starting phase, the quality of the fuel or the quality of the air/fuel mixture essentially does not have to be taken into account. The conditions of the reformation process may be adapted in a targeted manner to the other requirements of the operating phase and can be kept stable in the process. A stable sequence of the reaction process is permitted. Furthermore, the solution according to the invention makes it possible to optimize the reformation process without taking into account corresponding marginal conditions owed to the HC emission behavior with respect to rapid-start capability and/or durability.

The operating behavior of the consuming device is influenced by the reformat gas temperature, the temperature gradients of the reformate gas, and/or the concentration of hydrocarbons. Because of the dependence of the adsorption/desorption behavior of the HC adsorber on the reformate gas temperature, the influence of the time-dependent change of the reformate gas temperature on the operating behavior of the consuming device is correspondingly taken into account.

In the operating phase, for example, at the start of the reformer process, during which a large amount of hydrocarbons is generated, the HC adsorber according to the invention may have a high adsorption capacity influenced by a low reformate gas temperature. In this phase, the reformate gas reaching the consuming device is essentially free of hydrocarbons (or contains only a small fraction of hydrocarbons). In this phase, the consuming device is, for example, still “cold” and would be hindered in its operation by a high fraction of hydrocarbons, or the gases expelled by the consuming device would be characterized by high emissions.

In the further course of the reformer process, for example, in the time segment following the starting phase, the reformate gas temperature now rises, which has the effect that the HC adsorber adsorbs fewer hydrocarbons. However, now the consuming device connected on the output side is less hindered in its function by the reformate gas temperature, even when the hydrocarbon fraction in the reformate gas is increased, or is capable of processing the hydrocarbons such that the gases expelled by the consuming device are less burdened by hydrocarbons. When the reformate gas temperature reaches a certain threshold value, the hydrocarbons previously adsorbed by the HC adsorber are emitted again by the latter. However, at this reformate gas temperature, the consuming device is in a condition in which the latter can process a large quantity of hydrocarbons in the reformate gas without being significantly impaired in its function (or without generating undesirable emissions).

With the reformer system according to the invention, the reformate gas produced by the reformer may, therefore, be processed without any problem; that is, without impairing the operation of the consuming device or without generating undesirable pollutants to an excessive extent. When the reformate gas is fed to an exhaust gas aftertreatment system of an internal-combustion engine operating as a consuming device, a significant desorption of hydrocarbons from the HC adsorber is to take place only after, for example, a catalyst provided in the exhaust gas aftertreatment system has reached or exceeded its light-off temperature. One embodiment according to the invention thereby permits a reduction of the hydrocarbons situated in the HC adsorber without a corresponding stressing of the environment by hydrocarbon emissions.

Advantageously, the operating phase of the reformer includes a starting phase during which the chronological progression of the adsorption/desorption behavior of the HC adsorber, as a function of the reformate gas temperature, which rises in the starting phase with respect to the time, and/or a temperature gradient of the reformate gas occurring in the starting phase, is coordinated with the chronological course of the operating behavior of the consuming device. This is done such that a significant desorption of hydrocarbons from the HC adsorber takes place only when the consuming device is in an operating condition in which the desorbed hydrocarbons are processed by the consuming device such that the hydrocarbon fraction of the gases expelled by the consuming device, and/or the function of the consuming device, is/are not significantly influenced by the desorbed hydrocarbons.

In an advantageous embodiment, the consuming device includes an exhaust gas aftertreatment system, an internal-combustion engine, and/or a fuel cell. An internal-combustion engine may, for example, be provided as the consuming device of the reformate gas, to which internal-combustion engine the hydrogen-gas-rich reformate gas is fed for minimizing its cold-start, warm-up and engine-off emissions. According to the present embodiment of the invention, a significant desorption of hydrocarbons will take place only when the combustion conditions in the internal-combustion engine have stabilized such that the additional hydrocarbon content of the reformate gas has no negative effect on the HC emissions of the internal-combustion engine.

In a preferred embodiment, the coordination of the adsorption/desorption behavior of the HC adsorber as a function of the reformate gas temperature takes place by the suitable selection of the material of the HC adsorber and/or the suitable positioning of the HC adsorber. With the suitable positioning of the HC adsorber in closer proximity to, or at a farther distance from, the reformer, the reformate gas temperature may be correspondingly adapted to the adsorption/desorption behavior of the HC adsorber by the natural cooling of the reformate gas along the route.

In an advantageous embodiment, the hydrocarbon-containing fuel, which can be converted by the reformer, is liquid and contains particularly gasoline, diesel and/or alcohols. An adsorption of hydrocarbons following the reformation process was found to be particularly advantageous in the case of a reformate gas produced from liquid fuel. This is particularly the result of the fact that, when liquid fuel is used, the emission behavior during the reformer start deteriorates even more because, at a low temperature, the homogenization process, which takes place before the reformation reaction between a liquid medium and air, becomes difficult.

In order to withdraw hydrocarbons from the reformate gas in a particularly effective manner, it is expedient for the HC adsorber to have activated carbon and/or a substance with a pore structure functioning as a molecular sieve, particularly zeolite. In this case, it is particularly advantageous for this substance to be applied to monolithic carrier substances and, if required, to additionally be catalytically activated. The HC adsorber can advantageously be based on adsorber materials and methods, which are also used for the minimization of HC emissions from the fuel supply system or of engine emissions during the start and warm-up of an internal-combustion engine.

In an advantageous embodiment, the function of the HC adsorber is coordinated with the reformate gas temperature such that, at an inversion temperature of the reformate gas, the adsorption of the hydrocarbons from the reformate gas is compensated by a desorption of the adsorbed hydrocarbons to the reformate gas, and that the adsorption predominates below the inversion temperature and the desorption predominates above the inversion temperature. At this point, it is noted that the inversion temperature for a typical reformate gas is not a fixed value, but rather a range in which adsorption is still present for certain species but desorption is present for other species. This is a result of the fact that an individual inversion temperature exists for each HC species.

By way of the selection and design of the adsorber material of the HC adsorber, the adsorption and desorption behavior can be quasi-selectively optimized by way of the temperature with respect to certain hydrocarbon species. In other words, a positive adsorption balance exists below the inversion temperature; that is, a greater number of hydrocarbon molecules are deposited on the HC adsorber per time unit than can be desorbed from this adsorber in this time unit. A negative adsorption balance or a positive desorption balance now exists above the inversion temperature. The value of the inversion temperature depends on the physical boundary conditions, such as the pressure of the reformate gas, the degree of saturation of the HC adsorber and/or the water content of the reformate gas, as well as the type of the adsorbed hydrocarbon species and the selection of the adsorber material.

As a result of the temperature-dependent inversion behavior of the hydrocarbon adsorption according to the invention, the reformer system may be operated as follows. During the starting and run-up phase of the reformer system, in which hydrocarbons are produced in large quantities, because of the relatively low reformate gas temperature, the HC adsorber will have a high adsorption capacity for the hydrocarbon molecules. Subsequently, the reforming process will stabilize, which causes the hydrocarbon emissions from the reformer to be reduced to an uncritical amount. In this phase, the reformate temperature is above the inversion temperature of the HC adsorber, whereby a desorption takes place of the hydrocarbons adsorbed during the start and the run-up of the reformer. This desorption expediently takes place at a rate compatible with the consuming device of the reformate gas. Since the hydrocarbon load of the reformate gas leaving the reformer is very low, the overall hydrocarbon concentration in the reformate gas fed to the consuming device can still be kept within acceptable limits by desorption from the HC adsorber, even in the case of a certain increase of the hydrocarbon content. Because of the gradual desorption of the hydrocarbons from the HC adsorber during normal operation, the HC adsorber is evacuated to such an extent that, during a new starting process of the reformer, it will again be sufficiently absorptive.

In a further preferred embodiment, in which the reformate gas during the operation of the reformer in a temperature equilibrium occurring after a start-up phase of the reformation process assumes a constant equilibrium temperature, it is advantageous for the inversion temperature of the HC adsorber to be lower than the equilibrium temperature of the reformate gas, and/or for the adsorption capability of the HC adsorber for hydrocarbons, particularly for the hydrocarbon species contained in the reformate gas, to have a maximum at a temperature which is low relative to the equilibrium temperature, particularly at a temperature of maximally 100° C. An HC adsorber designed in such a manner with respect to its type and structure permits an optimal hydrocarbon reduction of the reformate gas during the starting phase of the reformer, in which the hydrocarbon fraction is the highest in the reformate gas.

In order to be able to empty the HC adsorber of hydrocarbons within a very short time and thus permit it to be ready for a new starting phase of the reformer, it is expedient for the HC adsorber to be designed such that hydrocarbons of the HC adsorber adsorbed at a temperature of the reformate gas above an evacuation temperature desorb without delay and completely to the reformate gas. In other words, the hydrocarbons of the HC adsorber should desorb within a very short time, if possible, 100% in a relevant temperature range above the evacuation temperature. In this case, the evacuation temperature may preferably be above the inversion temperature. The exact value of the evacuation temperature, as also the value of the inversion temperature, depend on physical boundary conditions, such as the pressure of the reformate gas, the degree of saturation of the HC adsorber, and/or the water content of the reformate gas, as well as the type of the adsorbed hydrocarbon species and the selection of the adsorber material.

In order not to exceed the adsorbing capacity for hydrocarbon of a consuming device coupled on an output side of the reformer system at lower reformate gas temperature, it is advantageous for the HC adsorber to be designed such that, at a temperature of the reformate gas below the evacuation temperature, previously adsorbed hydrocarbons of the HC adsorber desorb to the reformate gas at a rate which is low relative to the desorption rate above the evacuation temperature. Advantageously, the HC adsorber has this relatively low desorption rate in a temperature range between the inversion temperature and the evacuation temperature. Furthermore, it is advantageous for the desorption rate of the HC adsorber in the temperature range between the inversion temperature and the evacuation temperature to be lower than the adsorption rate of the HC adsorber at a temperature below the inversion temperature.

In order to adjust the temperature of the reformate gas exiting from the reformer optimally to a temperature at which the HC adsorber has a suitable adsorption or desorption capability, it is advantageous for the reformer system to have a heat exchanger connected to the output side of the reformer, by which the temperature of the reformate gas can be changed, particularly reduced. In this case, the heat exchanger is connected in front of the HC adsorber and/or the HC adsorber is integrated in the heat exchanger; in particular, hydrocarbon-adsorbing material of the HC adsorber is contained in the walls of the heat exchanger. In other words, in a first alternative, the heat exchanger and the HC adsorber are two separate devices, in which case the reformate gas leaving the reformer first passes through the heat exchanger and is then guided through the HC adsorber at a temperature adapted to the adsorption or desorption behavior of the HC adsorber. In this case, the type and structure of the material of the HC adsorber is selected such that the temperature window of the HC adsorber in which the desorption of the hydrocarbons to the reformate gas takes place, is selected such that it contains the reformate gas temperatures which adjust themselves or can be adjusted by way of a heat exchange.

In a second alternative, in which the HC adsorber is integrated in the heat exchanger, the hydrocarbon exchange with the HC adsorber takes place simultaneously with the temperature change of the reformate gas by way of the heat exchanger. This alternative is particularly space-saving. A material with zeolitic structures is particularly suitable as a hydrocarbon-adsorbing material for the integration into the walls of the heat exchanger.

Preferably, the HC adsorber is arranged behind the reformer system or behind the heat exchanger in a position in which an adjustment of the adsorption or desorption temperature window optimal for the overall process on the HC adsorber can be carried out best.

In another preferred embodiment, the heat exchanger is designed for adjusting the temperature of the reformate gas to a particularly optimal temperature suitable for the adsorption or for the desorption, of the hydrocarbons by the HC adsorber. In other words, when a heat exchanger is used behind the reformer system and the HC adsorber is arranged behind this heat exchanger, the heat output of the reformate gas in the heat exchanger is preferably controlled such that the adsorption and desorption of the hydrocarbons on the, and from, the HC adsorber takes place in a temperature window optimal with respect to the adsorption or desorption efficiency.

For certain usages of the reformate in the exhaust gas aftertreatment system, it is desirable to feed greater quantities of hydrocarbons to the exhaust gas aftertreatment system. For this purpose, in an advantageous embodiment, the reformer system according to the invention has removal devices by which at least a portion of the reformate gas may be branched off from the reformate gas current before entering into the HC adsorber between the output of the reformer and the HC adsorber, particularly in front of and/or behind the heat exchanger and can be fed to a consuming device, particularly to an exhaust gas aftertreatment system. In certain usages, it may also be useful to bring additional heat into the exhaust gas by way of hot reformate. In this case, it may be advantageous to remove the reformate gas from the reformate gas flow in front of the heat exchanger.

Other objects, advantages and novel features of the present invention will become apparent from the following detailed description of the invention when considered in conjunction with the accompanying drawings.

### BRIEF DESCRIPTION OF THE DRAWINGS

In the following, an embodiment of a reformer system according to the invention will be explained in detail by way of the attached schematic drawings.

FIG. 1 is a simplified view of an embodiment of a reformer system according to the invention with consuming devices connected thereto; and

FIG. 2 is a simplified view of the reformer system according to FIG. 1 having a heat exchanger.

### DETAILED DESCRIPTION OF THE DRAWINGS

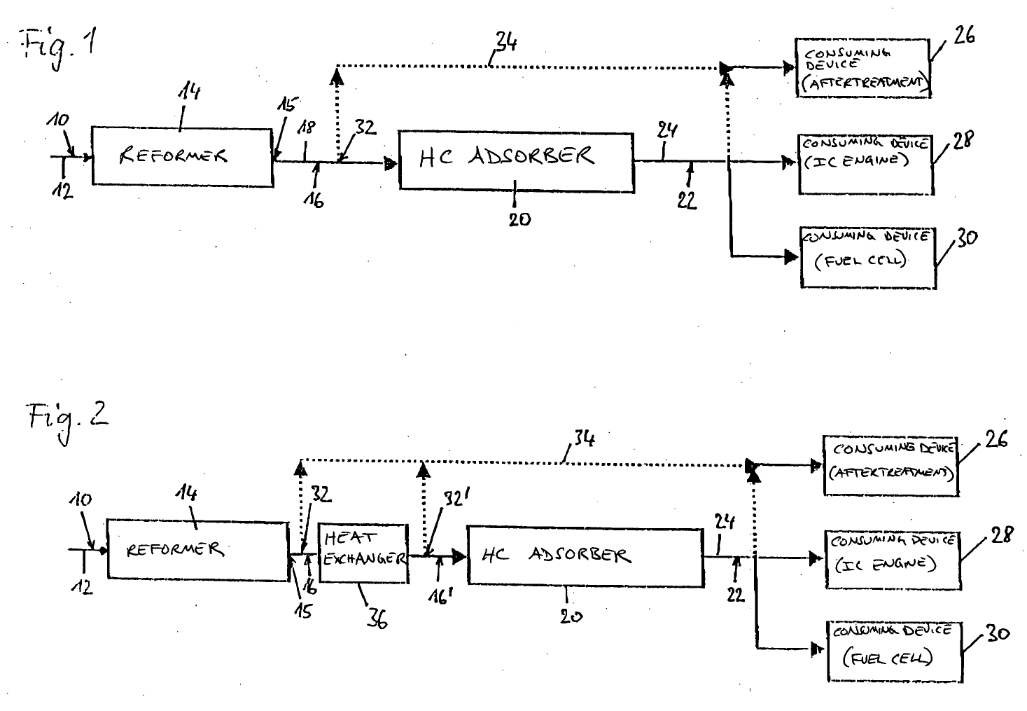

FIG. 1 schematically illustrates a reformer system according to the invention. This reformer system includes a fuel line 10 in which liquid fuel 12, such as a gasoline, diesel, military fuels such as JP8 or the like, or other fuels such as kerosene biodiesel, alcohol, or oxygenated fuels or the like, can be fed to a reformer 14. In the reformer 14, the liquid fuel first arrives in a mixture forming zone, in which it is mixed by evaporation with air fed from the outside. Then the air/fuel mixture is converted in a reaction zone of the reformer 14 by way of a reforming process to a hydrogen-gas-rich reformate gas. Partial oxidation, steam reformation, CO₂ reformation, cracking, or combinations thereof, such as autothermal reformation, may be used as reforming methods. For increasing the hydrogen yield, a so-called shift reaction may be connected on the output side. For the gasoline and diesel fuels, the formation processes without a catalyst take place at approximately 1,500° C. In this case, the reformation temperature may be lowered to approximately 800 to 1,000° C. by using a catalyst. The reformate gas or synthesis gas created by the reformation process exits at the output 15 of the reformer 14 and consists of hydrogen (H₂), carbon monoxide CO) and inert gas (N₂,CO₂,H₂O). The reformate gas 18 is then fed to an HC adsorber 20 by way of a gas line 16.

The HC adsorber 20 may have an activated carbon filter or pore structures functioning as molecular sieves, such as zeolites, which are applied to monolithic carrier substrates and, if required, may additionally be catalytically activated. By adsorption, the HC adsorber 20 withdraws hydrocarbons contained in the reformate gas 18 from the reformate gas 18. However, this adsorption operation takes place only for temperatures of the reformate gas below a certain inversion temperature. If the reformate gas has a higher temperature, a desorption takes place of hydrocarbon molecules deposited in the HC adsorber by way of the preceding adsorption process to the reformate gas 18. The type and structure of the material adsorbing the hydrocarbons is designed such that, at temperatures occurring during the starting phase of the reformer 14 for the reformate gas 18, a maximal adsorption capability of the HC adsorber 20 exists. At reformate gas temperatures at which the reformer 14 is already in a stable operating condition, the produced reformate gas 18 contains barely more hydrocarbon emissions. At these reformate gas temperatures, the HC adsorber 20 is in the operating mode in which the hydrocarbons are again desorbed very slowly.

The treated reformate gas 24 is fed to a consuming device, such as an exhaust gas aftertreatment system 26, an internal-combustion engine 28, and/or a fuel cell 30. In addition, untreated reformate gas 18 may be removed by way of a branch-off element 32 from the gas line between the reformer 14 and the HC adsorber 20 and may be fed to the exhaust gas aftertreatment system 26 by way of another gas line 34.

In the embodiment of the reformer system according to the invention illustrated in FIG. 2, a heat exchanger 36 is connected between the reformer 14 and the HC adsorber 20. This heat exchanger 36 is used for either increasing or decreasing the temperature of the untreated reformate gas 18 in order to thereby optimize the adsorption or desorption yield in the HC adsorber 20 connected on the output side. In this case, the temperature of the reformate gas 18 entering into the HC adsorber 20 may be coordinated during the staring phase of the reformer 14 for causing an optimal adsorption of the hydrocarbons contained therein in the HC adsorber 20.

In this phase, the consuming device, such as the internal-combustion engine 28, is still “cold” and would be hindered in its function by a high hydrocarbon fraction or the gases expelled by the internal-combustion engine 28 would be characterized by high emissions. In the further course of the reformer process, the reformate gas temperature now rises continuously, which has the effect that the HC adsorber 20 adsorbs fewer hydrocarbons. However, the internal-combustion engine 28 connected to the output side is now less hindered in its function by the reformate gas temperature even at an increased hydrocarbon fraction in the reformate gas (or is capable of processing hydrocarbons such that the gases expelled by the internal-combustion engine 28 are less stressed by hydrocarbons). When the reformate gas temperature reaches a certain threshold value, the hydrocarbons previously adsorbed by the HC adsorber 20 are emitted again by the latter. However, at this reformate gas temperature, the internal-combustion engine 28 is in a condition in which it can process a large quantity of hydrocarbons in the reformate gas without being significantly impaired in its function or without producing undesired emissions.

In the stable operating condition of the reformer 14, the temperature of the reformate gas 18 may also be adjusted to a desired desorption rate of hydrocarbons from the HC adsorber 20. In the embodiment illustrated in FIG. 2, a branch-off element 32 and 32′, respectively, is provided in front of as well as behind the heat exchanger 38 for feeding the untreated reformate gas 18 to the exhaust gas aftertreatment system 26. When the reformate gas 18 is removed in front of the heat exchanger 36 by way of the branch-off element 32, additional heat may be fed into the exhaust gas of the exhaust gas treatment system 26.

Table of Reference Numbers

| | |
|---|---|
| 10 | fuel line |
| 12 | fuel |
| 14 | reformer |
| 15 | output of the reformer |
| 16,16′ | gas line |
| 18 | untreated reformate gas |
| 20 | HC adsorber |
| 22 | gas line |
| 24 | treated reformate gas |
| 26 | exhaust gas aftertreatment system |
| 28 | internal-combustion engine |
| 30 | fuel cell |
| 32,32′ | branch-off element |
| 34 | gas line |
| 36 | heat exchanger |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A reformer system, comprising:
a reformer for converting a hydrocarbon-containing fuel to a hydrogen-gas-rich reformate gas;
an HC adsorber which is coupled to an output side of the reformer, for adsorbing, as a function of temperature, hydrocarbons contained in the reformate gas or for desorbing previously adsorbed hydrocarbons to the reformate gas;
wherein the reformer system transmits the reformate gas after passing through the HC adsorber to a consuming device;
further wherein a chronological progression of the adsorption/desorption behavior of the HC adsorber during an operating phase of the reformer as a function of the reformate gas temperature occurring in the operating phase, and/or a temperature gradient of the reformate gas occurring in the operating phase, is coordinated with the chronological progression of the operating behavior of the consuming device such that a significant desorption of hydrocarbons from the HC adsorber takes place only when the consuming device is in an operating condition in which the desorbed hydrocarbons are processed by the consuming device such that at least one of the hydrocarbon fraction of the gases expelled from the consuming device and the function of the consuming device is not significantly influenced by the desorbed hydrocarbons.

2. The reformer system according to claim 1, wherein the operating phase of the reformer includes a starting phase during which the chronological progression of the adsorption/desorption behavior of the HC adsorber, as a function of the reformate gas temperature, which rises in the starting phase with respect to time, and/or a temperature gradient of the reformate gas occurring in the starting phase, is coordinated with the chronological progression of the operating behavior of the consuming device such that a significant desorption of hydrocarbons from the HC adsorber takes place only when the consuming device is in an operating condition in which the desorbed hydrocarbons are processed by the consuming device such that at least one of the hydrocarbon fraction of the gases expelled by the consuming device and the function of the consuming device is not significantly influenced by the desorbed hydrocarbons.

3. The reformer system according to claim 1, wherein the consuming device comprises at least one of: an exhaust gas aftertreatment system, an internal-combustion engine, and a fuel cell.

4. The reformer system according to claim 1, wherein coordination of the adsorption/desorption behavior of the HC adsorber as a function of the reformate gas temperature takes place by at least one of: a suitable selection of an HC adsorber material, and a suitable positioning of the HC adsorber.

5. The reformer system according to claim 1, wherein the hydrocarbon-containing fuel, which is convertable by the reformer, is liquid and contains at least one of: gasoline, diesel, military fuels, kerosene biodiesel, alcohol and oxygenated fuels.

6. The reformer system according to claim 1, wherein the HC adsorber has at least one of activated carbon and a substance with a pore structure functioning as a molecular sieve.

7. The reformer system according to claim 6, wherein the molecular sieve is formed by zeolite.

8. The reformer system according to claim 1, wherein a function of the HC adsorber is coordinated with the reformate gas temperature such that, at an inversion temperature of the reformate gas, the adsorption of the hydrocarbons from the reformate gas is compensated by a desorption of the adsorbed hydrocarbons to the reformate gas, and further wherein the adsorption predominates below the inversion temperature and the desorption predominates above the inversion temperature.

9. The reformer system according to claim 8, wherein the reformate gas during operation of the reformer in a temperature equilibrium occurring after a start-up phase of the reformation process assumes a constant equilibrium temperature, the inversion temperature of the HC adsorber being lower than the equilibrium temperature of the reformate gas, and/or the adsorption capability of the HC adsorber for hydrocarbons.

10. The reformer system according to claim 9, wherein hydrocarbon species contained in the reformate gas have a maximum temperature of 100° C. which is low relative to the equilibrium temperature.

11. The reformer system according to one claim 1, wherein the HC adsorber is designed such that hydrocarbons of the HC adsorber adsorbed at a temperature of the reformate gas above an evacuation temperature desorb without delay and completely to the reformate gas.

12. The reformer system according to claim 11, wherein the HC adsorber is designed such that, at a temperature of the reformate gas below the evacuation temperature, previously adsorbed hydrocarbons of the HC adsorber desorb to the reformate gas at a rate which is low relative to the desorption rate above the evacuation temperature.

13. The reformer system according to claim 1, further comprising:
a heat exchanger coupled to the output side of the reformer, by which heat exchanger the temperature of the reformate gas is reduceable;
wherein the heat exchanger is coupled in front of the HC adsorber and the HC adsorber is integrated in the heat exchanger.

14. The reformer system according to claim 13, wherein hydrocarbon-adsorbing material of the HC adsorber is contained on walls of the heat exchanger.

15. The reformer system according to claim 13, wherein the heat exchanger is designed for adjusting the temperature of the reformate gas to a particularly optimal temperature suitable for the adsorption or for the desorption of the hydrocarbons by the HC adsorber.

16. The reformer system according to claim 1, further comprising:
removal devices by which at least a portion of the reformate gas is branched off from the reformate gas flow before entering into the HC adsorber between the output of the reformer and the HC adsorber and is fed to an exhaust gas aftertreatment system.

17. A vehicle having a reformer system according to claim 1, wherein the consuming device is at least one of: an internal-combustion engine, a fuel cell and an exhaust gas aftertreatment system; gas feeding devices feeding the reformate gas after passing though the HC adsorber to the consuming device.

18. A method of reforming a hydrocarbon-containing fuel with: a conversion of the hydrocarbon-containing fuel to a hydrogen-rich reformate gas via a reformation process; a temperature-dependent adsorbing of hydrocarbons contained in the reformate gas on an HC adsorber or desorbing of previously adsorbed hydrocarbons to the reformate gas; and a transmission of the reformate gas after passing through the HC adsorber to a consuming device, the method comprising the acts of:
coordinating a chronological progression of the adsorption/desorption behavior of the HC-adsorber during an operating phase of the reformer as a function of at least one of the reformate gas temperature occurring in the operating phase and a temperature gradient of the reformate gas occurring in the operating phase with the chronological progression of the operating behavior of the consuming device such that a significant desorption of hydrocarbons from the HC adsorber takes place only when the consuming device is in an operating condition in which the desorbed hydrocarbons are processed by the consuming device such that at least one of the hydrocarbon fraction of the gases expelled from the consuming device and the function of the consuming device is not significantly influenced by the desorbed hydrocarbons.

19. The method according to claim 18, further comprising the act of:
coordinating an operating phase of the reformer, including a starting phase during which the chronological progression of the adsorption/desorption behavior of the HC adsorber, as a function of the reformate gas temperature, which rises in the starting phase with respect to the time, and/or a temperature gradient of the reformate gas occurring in the starting phase, with the chronological progression of the operating behavior of the consuming device such that a significant desorption of hydrocarbons from the HC adsorber takes place only when the consuming device is in an operating condition in which the desorbed hydrocarbons are processed by the consuming device such that at least one of the hydrocarbon fraction of the gases expelled by the consuming device and a function of the consuming device is not significantly influenced by the desorbed hydrocarbons.

20. The method according to claim 18, wherein the consuming device comprises at least one of an exhaust gas aftertreatment system, an internal-combustion engine and a fuel cell.

21. The method according to claim 19, wherein the consuming device comprises at least one of an exhaust gas aftertreatment system, an internal-combustion engine and a fuel cell.

22. The method according to claim 18, wherein the coordination act of the adsorption/desorption behavior of the HC adsorber as a function of the reformate gas temperature takes place by at least one of a suitable selection of the material of the HC adsorber and a suitable positioning of the HC adsorber.

23. The method according to claim 18, wherein the reformation process comprises at least one of a partial oxidation process, a steam reformation process, a CO₂ reformation process, and a cracking process.

24. The method according to claim 18, wherein the hydrocarbon-containing fuel converted by way of the reformation process is liquid and contains one of: gasoline, diesel, military fuels, kerosene biodiesel, alcohol, and oxygenated fuels.

25. The method according to claim 18, wherein the HC adsorber has at least one of activated carbon and a substance with a pore structure functioning as a molecular sieve.

26. The method according to claim 25, wherein the molecular sieve is formed of zeolite.

27. The method according to claim 18, wherein, at an inversion temperature of the reformate gas, the adsorption of the hydrocarbons from the reformate gas is compensated by a desorption of the adsorbed hydrocarbons to the reformate gas, and further wherein the adsorption predominates below the inversion temperature and the desorption predominates above the inversion temperature.

28. The method according to claim 27, wherein the reformation process occurs after a starting phase in a temperature equilibrium, during which the reformate gas assumes a constant equilibrium temperature, the inversion temperature of the HC adsorber being selected lower than the equilibrium temperature of the reformate gas, and/or the adsorption capability of the HC adsorber for hydrocarbons.

29. The method according to claim 28, wherein hydrocarbon species contained in the reformate gas have a maximum temperature 100° C. which is low relative to the equilibrium temperature.

30. The method according to claim 18, wherein hydrocarbons adsorbed at the HC adsorber at a temperature of the reformate gas above an evacuation temperature desorb without delay and completely to the reformate gas.

31. The method according to claim 30, wherein, at a temperature of the reformate gas below the evacuation temperature, previously adsorbed hydrocarbons of the HC adsorber are desorbed to the reformate gas at a rate which is low relative to the desorption rate above the evacuation temperature.

32. The method according to claim 18, wherein the reformate gas flows through a heat exchanger for reducing the temperature of the reformate gas, before and/or during the adsorption or desorption of the hydrocarbons.

33. The method according to claim 18, wherein at least a portion of the reformate gas is branched off from the reformate gas current before an adsorption or desorption of the hydrocarbons, and is fed to a consuming device comprising an exhaust gas aftertreatment system, the branching-off taking place before and/or after the reformat gas passes through the heat exchanger.
